(19) United States
(12) Patent Application Publication
(10) Pub. No.: US 2006/0163551 A1
(43) Pub. Date: Jul. 27, 2006

(54) Hydraulic vehicle jack system

(76) Inventors: Duane Coenen, Seymour, WI (US); Brian Kaster, Pulaski, WI (US)

Correspondence Address: LAW OFFICE OF STEVEN B. LEAVITT, 9914 WATERVIEW PARKWAY, ROWLETT, TX, 75089, US

(21) Appl. No.: 11/341,258

(22) Filed: Jan. 27, 2006

Related U.S. Application Data
(60) Provisional application No. 60/647,480, filed on Jan. 27, 2005.

(51) Int. Cl. B60S 9/02

(52) U.S. Cl. 254/423

(57) ABSTRACT

A hydraulic vehicle jack system that safely lifts vehicles without using the vehicle as a power source power source and without moving mechanical parts. The system comprises: (a) a hydraulic vehicle jack mounted to the chassis of a vehicle near one of its wheels; (b) a hydraulic pump system to provide pressurized fluid to the hydraulic vehicle jack; and (c) a control device to activate the hydraulic pump system. Also disclosed is a method for lifting a vehicle.

This application claims the benefit of U.S. Provisional Application No. 60/647,480, filed Jan. 27, 2005, which is incorporated herein by reference.

### BACKGROUND OF INVENTION

1. Technical Field

The present invention relates generally to jack systems for lifting vehicles and, more particularly, to a hydraulic vehicle jack system that safely lifts vehicles without using the vehicle as a power source and without moving mechanical parts.

2. Description of Related Art

Jacks are used to raise a variety of vehicles such as automobiles and trucks from the ground. Most commonly, these devices are used when the vehicle must be lifted to repair or perform maintenance upon it. For example, a portion of an automobile must be raised in order to change a tire.

Many of these jacks are stowed in the vehicle, usually in the trunk. To remove the jack, the user is typically required to remove various items from the trunk first. Once the jack is removed, users that are not familiar with the jack may find it difficult to position beneath the vehicle and operate the jack. Often, the inexperienced or unfamiliar user may need to consult the jack's instruction manual.

Self-contained jack systems or systems integrated into the vehicle itself eliminate the need for the user to remove the jack from storage and position it beneath the vehicle in order to operate it. Some of these devices include hydraulic systems that further increase the device's ease of use by reducing, or eliminating, the amount of physical effort needed to operate the jack and lift the vehicle.

However, much of the prior art uses the vehicle as the source of power for operating the jack. In addition, many of the prior art jacks rely on moving mechanical parts. Eliminating the need for moving mechanical parts would reduce the opportunity for the device to malfunction or require repair and would makes the jack safer to use.

What is needed is a self-contained jack system that is not supplied with power from the vehicle and has no moving mechanical parts.

### SUMMARY OF INVENTION

The present invention addresses the foregoing problems by eliminating the use of moving mechanical parts and the need for power from the vehicle to be supplied to the jack. Thus, the hydraulic vehicle jack system is a device that is safer when used, requires less maintenance, and facilitates easier repairs. The hydraulic vehicle jack system comprises a hydraulic vehicle jack mounted to the chassis of a vehicle near one of its wheels, a hydraulic pump system to provide pressurized fluid to the hydraulic vehicle jack, and a control device to activate the hydraulic pump system.

The hydraulic vehicle jack comprises an outer cylinder with an inner piston rod that slides vertically within the outer cylinder. The lower end of the inner piston rod is pivotably attached to a ground pad that engages the surface beneath the vehicle.

The hydraulic pump system is comprised of a pump, a fluid reservoir connected to the pump, a valve connected to the pump and fluid reservoir, and a plurality of hydraulic lines emanating from the valve. The lines are connected to ports formed in the outer cylinder of the hydraulic vehicle jack and supply hydraulic fluid to the vehicle jack. The pump system, preferably powered by a source independent of the vehicle, is integrated into the vehicle where it can be operated safely.

To operate the hydraulic vehicle jack, the control device, preferably a keyed unit in a location easily accessible to the vehicle's driver, activates the hydraulic pump system. The pump system sends pressurized fluid, preferably an oil, to the outer cylinder of the jack. As the outer cylinder fills with fluid, the inner piston rod extends vertically and raises the vehicle off the ground. All this achieved without the use of gears, cranks or belts; thus, eliminating mechanical moving parts and increasing the safety of the device.

### BRIEF DESCRIPTION OF DRAWINGS

The novel features believed characteristic of the main invention are set forth in the appended claims. The invention itself, however, as well as a preferred mode of use, further objectives and advantages thereof, will be best understood by reference to the following summary of illustrative embodiments when read in conjunction with the accompanying drawings, wherein:

FIG. 1 is front view of a hydraulic vehicle jack in accordance with the present invention;

FIG. 2 is a side view of a hydraulic vehicle jack shown in FIG. 1;

FIG. 3 is front view of a hydraulic vehicle jack shown in FIG. 1 that includes the position of an additional mounting plate; and

FIG. 4 is a perspective view of a hydraulic pump system in accordance with the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

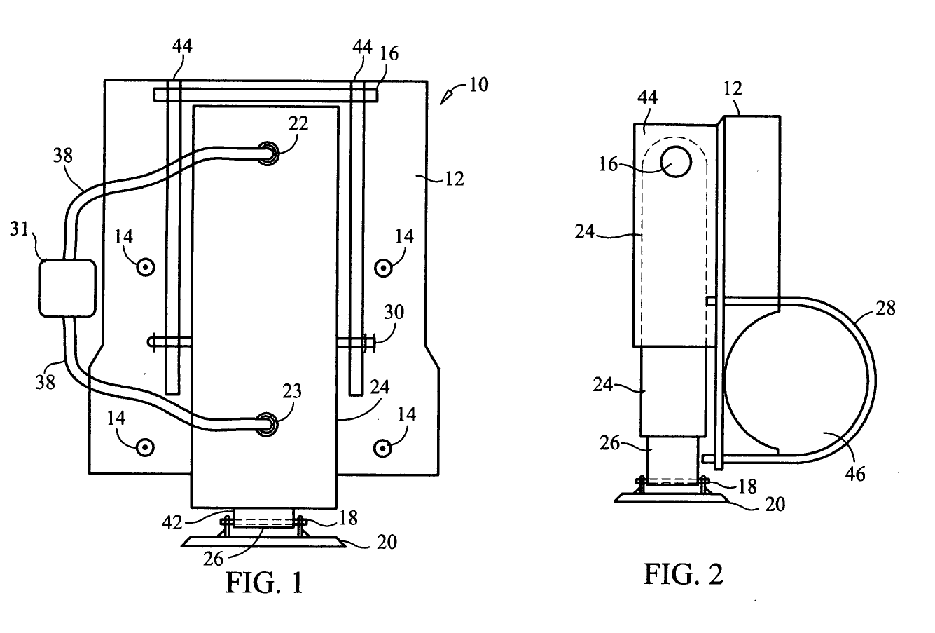

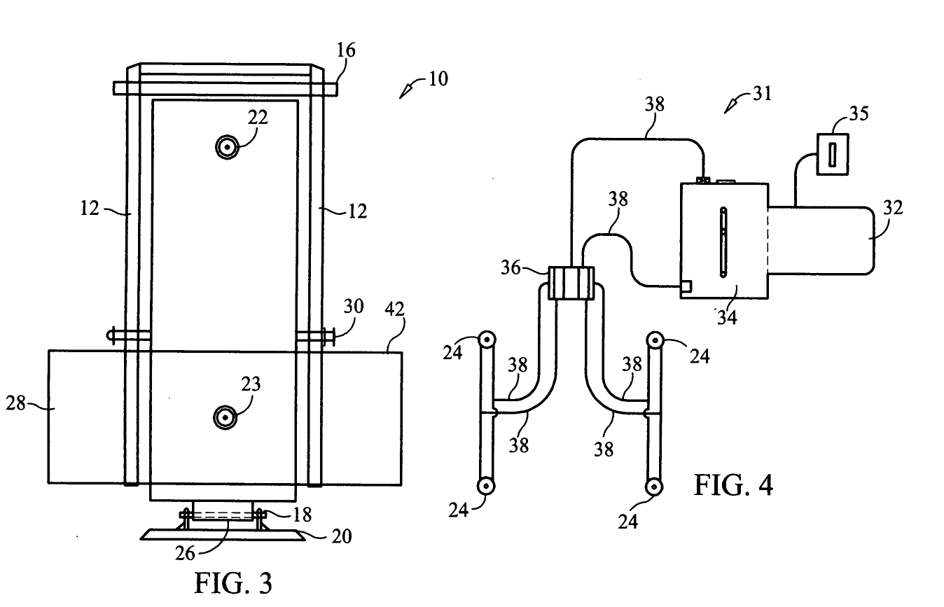

Referring to FIG. 1, shown is hydraulic vehicle jack 10. Hydraulic vehicle jack 10 includes mounting plate 12, extension port 22, retraction port 23, outer cylinder 24, inner piston rod 26, removable safety pin 30, swivel pin 18, ground pad 20, and pump system 31 shown in FIG. 4.

Mounting plate 12 is fixedly attached to a vehicle and may have holes 14 for use in securing mounting plate 12 to the vehicle. A bolt or screw for example may be passed through holes 14 to secure mounting plate 12 to the vehicle. Preferably, mounting plate 12 is secured on or near to the vehicle's axle case, proximate to at least one of the wheels and surrounding frame on the vehicle.

FIG. 2 shows mounting plate 12 attached to axle case 46 using U-bolt 28. Axle case 46 is a typical axle case on a vehicle, such as an automobile or pickup truck. U-bolt 28 has a profile sufficient to surround at least a portion of axle case 46 and is strong enough to secure mounting plate 12 to axle case 46. Mounting plate 12 is fixedly attached to outer cylinder 24.

Outer cylinder 24 contains at least a portion of inner piston rod 26. Inner piston rod 26 has an upper end (not shown) and an opposing lower end 42. Inner piston rod 26 slides vertically within outer cylinder 24. Opposing lower end 42 of inner piston rod 26 contains swivel pin 18.

Swivel pin 18 is attached to ground pad 20 such that ground pad 20 is pivotally attached to lower end 42 of piston rod 26. Ground pad 20 is relatively flat, capable of supporting at least a portion of a vehicle's weight, and will engage the surface beneath the vehicle when jack 10 is in use for lifting the vehicle.

In another embodiment, mounting plate 12 contains two parallel side walls 44 which extend perpendicularly from mounting plate 12. Side walls 44 contain mounting cylinder 16 which extends through side walls 44 and outer cylinder 24.

Jack 10 is actuated by a hydraulic pump system 31 shown in FIG. 4. Pump system 31 comprises of activation switch 35, pump 32, fluid reservoir 34, valve 36, at least one hydraulic line 38, and power source 39, that powers pump 32. Power source 39 is preferably independent of vehicle's power system and may be a battery for example. Preferably, power source 39 is a rechargeable battery that can be recharged by the vehicle's alternator.

Valve 36 is attached to pump 32 and reservoir 34 either directly or by the use of flexible tubing such as hydraulic line 38. Hydraulic lines 38 of pump system 31 are attached to intake port 22 and outlet port 23 in outer cylinder 24. Hydraulic pump system 31 can be located anywhere in the vehicle where it can be operated safely.

Activation switch 35 is used to activate or deactivate pump 32 and open or close valve 36. Preferably, activation switch 35 is a keyed unit in a location that is easily accessed by the vehicle's driver.

To lift a vehicle, the user first activates hydraulic pump system 31 via activation switch 35 which may be conveniently located within the passenger compartment of the vehicle. Pump system 31 generates pressurized fluid, preferably a non-compressible fluid such as oil, and valve 36 opens allowing the pressurized fluid to fill outer cylinder 24 of hydraulic vehicle jack 10. When filled, inner piston rod 26 is forced downward and raises the corner of the vehicle where hydraulic vehicle jack 10 is mounted.

Upon completion of jack 10's use, activation switch 35 is used to deactivate hydraulic pump system 31. The pressurized fluid returns to the pump system's fluid reservoir 34. As the fluid drains from outer cylinder 24, the vehicle is lowered to the ground. To prevent hydraulic jack 10 from extending when not in use, a removable safety pin 30, traversing laterally through outer cylinder 24 and inner piston rod 26, may be employed.

In addition to be used to raise the vehicle for replacement of a wheel, hydraulic vehicle jack 10 may be operated to raise a portion of the vehicle from ground to render it immobile. Thereby, the theft of a vehicle having an activated jack 10 is deterred, if not prevented.

As detailed above, hydraulic vehicle jack 10 is raised and lowered by the use of pressurized fluid, provided by hydraulic pump system 31, filling into or draining from the jack's outer cylinder 24. Thereby, no gears, cranks or belts are used in the preferred embodiment. In addition, the hydraulic vehicle jack system itself is mounted onto the vehicle. No wheels or other means with which to move the system into position prior to operating the device is required. Therefore, the present invention eliminates moving mechanical parts that are inherently prone to failure.

While the invention has been particularly shown and described with reference to the preferred embodiment, it will be understood by those skilled in the art that variations in size, materials, shape, form, function and manner of operation, assembly and use, may be made without departing from the spirit and scope of the invention. Further, it is to be understood that the present invention is not limited to the sole embodiment described above but also may encompasses any and all embodiments within the scope of the following claims.

What is claimed is:

1. A hydraulic vehicle jack system comprising:
a hydraulic vehicle jack mounted to the chassis of a vehicle for lifting a portion of said vehicle from the ground;
a hydraulic pump system in communication with said hydraulic vehicle jack for providing pressurized fluid to actuate said hydraulic vehicle jack; and
a control device for activating said hydraulic pump system.

2. The system of claim 1 wherein said hydraulic vehicle jack further comprises:
an outer cylinder;
an inner piston rod that can slide vertically within said outer cylinder; and
a ground pad, pivotally attached to the lower end of said inner piston rod, that engages the surface beneath said vehicle.

3. The system of claim 1 wherein said hydraulic pump system further comprises:
a pump;
a fluid reservoir connected to said pump;
a valve connected to said pump and fluid reservoir;
a plurality of hydraulic lines, emanating from said valve, connected to ports formed in said outer cylinder; and
a power source for said pump independent of said vehicle.

4. The system of claim 1 wherein said control device comprises a keyed unit.

5. The system of claim 1 wherein said hydraulic vehicle jack is mounted to the rear axle case proximate to one of said vehicle's rear wheels and its surrounding frame.

6. The system of claim 3 wherein said hydraulic pump system is integrated into said vehicle where said pump system can be operated safely.

7. The system of claim 4 wherein said control device is in a location easily accessible to said vehicle's driver.

8. The system of claim 1 wherein said pressurized fluid is an oil.

9. A method for lifting a portion of a vehicle from the ground comprising:
mounting a hydraulic vehicle jack to the chassis of a vehicle near one of said vehicle's rear wheels;
integrating a hydraulic pump system into said vehicle in order to provide pressurized fluid to said hydraulic jack; and
activating said hydraulic pump system using a control device.

10. A hydraulic vehicle jack comprising:
a mountable hydraulic vehicle jack adapted for mounting to the chassis of a vehicle for lifting a portion of said vehicle from the ground;
a hydraulic pump system in communication with said hydraulic vehicle jack for providing pressurized fluid to actuate said hydraulic vehicle jack; and
a control device for activating said hydraulic pump system.

11. The jack of claim 10 wherein said hydraulic vehicle jack comprises:
an outer cylinder;
an inner piston rod that can slide vertically within said outer cylinder; and
a ground pad, pivotally attached to the lower end of said inner piston rod, that engages the surface beneath said vehicle.

12. The jack of claim 10 wherein said hydraulic vehicle jack comprises:
an outer cylinder;
an inner piston rod that can slide vertically within said outer cylinder; and
a ground pad, pivotally attached to the lower end of said inner piston rod, that engages the surface beneath said vehicle.

13. The jack of claim 10 wherein said control device comprises a keyed unit.

14. The jack of claim 10 wherein said hydraulic vehicle jack is mounted to the rear axle case proximate to one of said vehicle's rear wheels and its surrounding frame.

15. The jack of claim 10 wherein said hydraulic pump system further comprises:
a pump;
a fluid reservoir connected to said pump;
a valve connected to said pump and fluid reservoir;
a plurality of hydraulic lines, emanating from said valve, connected to ports formed in said outer cylinder; and
a power source for said pump independent of said vehicle.

16. The jack of claim 12 wherein said hydraulic pump system is integrated into said vehicle where said pump system can be operated safely.

17. The jack of claim 13 wherein said control device is in a location easily accessible to said vehicle's driver.

18. The jack of claim 10 wherein said pressurized fluid is an oil.
